(19) United States
(12) Patent Application Publication
(10) Pub. No.: US 2019/0217832 A1
(43) Pub. Date: Jul. 18, 2019

(54) METHOD AND DEVICE FOR OPERATING A BRAKING SYSTEM, AND BRAKING SYSTEM

(71) Applicant: Robert Bosch GmbH, Stuttgart (DE)

(72) Inventor: Andreas Bresser, Ludwigsburg (DE)

(21) Appl. No.: 16/311,552

(22) PCT Filed: Apr. 12, 2017
(86) PCT No.: PCT/EP2017/058823

§ 371 Date: Dec. 19, 2018

(30) Foreign Application Priority Data
Jun. 20, 2016 (DE) 102016210945.6
Jun. 27, 2016 (DE) 102016244421.2

(51) Int. Cl. B60T 8/32; B60T 17/22; B60T 7/04; B60T 8/17; B60T 8/171; B60T 13/20; B60T 13/66

(52) U.S. Cl. CPC B60T 8/326; B60T 17/22; B60T 7/042; B60T 8/17; B60T 2270/82; B60T 13/20; B60T 13/66; B60T 2250/00; B60T 8/171

(57) ABSTRACT

A method for operating a hydraulic braking system of a motor vehicle, including at least one hydraulically actuatable wheel brake, a brake pedal unit including an actuatable brake pedal for predefining a setpoint braking torque, and a pressure generator which is electrically actuated in order to generate a hydraulic pressure as a function of the setpoint braking torque, an electrical operating current of the pressure generator being limited to a first predefinable limiting value during normal operation. The brake pedal unit is monitored for the nature of actuation of the brake pedal, and the limitation of the operating current is canceled if highly dynamic actuation of the brake pedal is detected.

### FIELD OF THE INVENTION

The present invention relates to a method for operating a hydraulic braking system of a motor vehicle, including at least one hydraulically actuatable wheel brake, a brake pedal unit including an actuatable brake pedal for predefining a setpoint braking torque, and a pressure generator which is electrically actuated in order to generate a hydraulic pressure as a function of the setpoint braking torque, an electrical operating current of the pressure generator being limited to a first predefinable limiting value during normal operation. The present invention also relates to a device for carrying out the described method, and to a braking system including such a device.

### BACKGROUND INFORMATION

Methods, devices and braking systems of the type mentioned at the outset are believed to be understood from the related art. While in conventional braking systems a vacuum brake booster in the brake pedal unit is used to boost the braking force exerted by the driver on the brake pedal and to introduce the braking force into the hydraulic circuit of the braking system, braking systems are now also known in which the vacuum brake booster is omitted and instead an electrically actuatable pressure generator is used. The latter generates the hydraulic pressure without being mechanically coupled to the brake pedal. Instead, the actuation of the brake pedal is detected and monitored by one or multiple sensor(s) and the pressure generator is actuated as a function of the brake pedal actuation. The pressure generator is, for example, a pump to which an electric motor is assigned in order to set the pressure in the braking system electrohydraulically. In this case, the pressure generator is actuated in such a way that a setpoint braking torque requested by the driver by actuating the brake pedal is set on one or multiple wheel brake(s) of the braking system in order to decelerate the motor vehicle.

To prevent overheating of the pressure generator or its electric motor, the electric motor is actuated in such a way that, in the case of low rotational speeds, the torque and thus the operating current are limited to a first limiting value.

### SUMMARY OF THE INVENTION

The method according to the present invention, having the features described herein, has the advantage that the brake pedal unit is monitored for the nature of the actuation of the brake pedal, and the limitation of the operating current is canceled if a highly dynamic actuation is detected. The method according to the present invention has the advantage that the setpoint braking torque is made available to the driver within a short period of time in the event of highly dynamic braking operations, it nevertheless being ensured that overheating of the pressure generator, in particular of its electric motor, is permanently avoided. Since the limitation is canceled for highly dynamic braking operations, the user may request the braking torque within a short period of time in the event of a highly dynamic braking operation. Because a highly dynamic braking operation does not last for a long period of time, but rather is characterized in particular by its brevity, overheating of the electric motor as a result of the briefly increased load on the electric motor is virtually ruled out.

According to one refinement of the present invention it is provided that a highly dynamic actuation is recognized if a detected brake pedal actuation speed exceeds a predefinable second limiting value. For this purpose, the speed of actuation of the brake pedal is advantageously monitored and is compared with the second limiting value. If the detected speed exceeds the second limiting value, the above-described limitation of the operating current is canceled. The brake pedal actuation speed is ascertained in particular with the aid of a displacement sensor which is assigned to the brake pedal. The speed of movement of the brake pedal may be calculated by a simple derivation of the displacement signal over time, so that it is possible to decide, for the method over a short period of time, whether a detected braking operation or a detected brake pedal actuation is a highly dynamic actuation or a normal actuation.

In addition, it may be provided that a highly dynamic actuation is recognized when a detected brake pedal travel exceeds a predefinable third limiting value. In particular, independently of the consideration given to the brake pedal actuation speed, the brake pedal travel is compared with a third limiting value. The third limiting value is in particular selected in such a way as to prevent brake pedal actuations which take place at high speed, but which require only a low braking torque, from being detected as highly dynamic brake pedal actuations.

In addition, it may be provided that the first limiting value is predefined as a function of an operating temperature of the pressure generator. This yields the advantage that a dynamic actuation of the pressure generator takes place, which depends on the present operating temperature of the pressure generator. In particular, the present operating temperature is compared with a maximum permissible operating temperature in order to determine whether the temperature may or may not be permitted to rise further. The first limiting value is therefore varied so that the exceedance of the limiting temperature is reliably prevented. It is assumed here that highly dynamic braking operations increase the operating temperature only briefly and thus insignificantly.

In addition, according to one advantageous refinement, the limitation of the operating current by the first limiting value takes place only at rotational speeds below a fourth limiting value. Account is thus taken of the fact that, particularly at low rotational speeds, the torque for driving the pressure generator is high, so that especially here high operating currents occur which result in heating of the pressure generator, in particular of its electric motor. If the pressure generator is operating in a speed range at high rotational speeds, in which a high operating current is likewise required but a low torque is required due to the high rotational speed, the heating is lower and thus the limitation to the first limiting value may be omitted.

In particular, it is provided that the first limiting value is predefined as a function of a permissible operating temperature of the pressure generator during long-term brake application. In this case, the first limiting value is fixed in particular and not predefined dynamically and corresponds to the operating current, which during long-term brake application may be at a maximum without the operating temperature of the pressure generator exceeding the critical value.

According to one refinement of the present invention, it is provided that the brake pedal unit generates a status report as a function of the detected nature of the brake pedal actuation and sends it to a control unit which actuates the pressure generator. The brake pedal unit thus itself transmits to the control unit the information as to whether or not a highly dynamic brake pedal actuation has taken place, and as a function of this piece of information the control unit then actuates the pressure generator or cancels or adjusts the limitation by the first limiting value.

The device according to the present invention, having the features described herein, is characterized by a control unit which is specially configured to carry out the method according to the present invention under normal conditions of use. This yields the advantages already mentioned above.

The braking system according to the invention, having the features described herein, is characterized by the device according to the present invention. This yields the advantages already mentioned above.

Further advantages and features and feature combinations emerge in particular from the above description and from the descriptions herein.

The present invention will be discussed in greater detail below with reference to the drawings.

### BRIEF DESCRIPTION OF THE DRAWINGS

FIG. 1 shows a schematic diagram of a hydraulic braking system of a motor vehicle.

FIG. 2 bows a flow chart to explain one advantageous method for operating the braking system.

### DETAILED DESCRIPTION

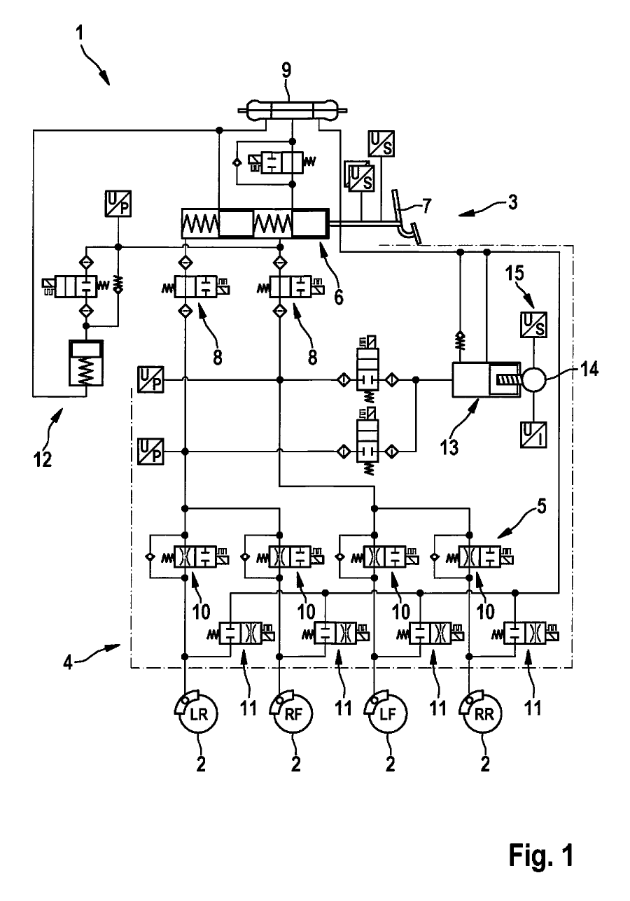

FIG. 1 shows, in a simplified diagram, a braking system 1 for a motor vehicle (not shown in greater detail here). Braking system 1 includes multiple wheel brakes 2, which may be actuated as service brakes by a driver of the motor vehicle by way of a brake pedal unit 3. Wheel brakes 2 are denoted by LR, RF, LF and RR, which explains their position or assignment on the motor vehicle, where LR stands for left rear, RF for right front, LF for left front and RR for right rear. Two brake circuits 4 and 5 are formed between brake pedal unit 3 and wheel brakes 2, brake circuit 4 being assigned to wheel brakes LF and RR and brake circuit 5 being assigned to wheel brakes LR and RF. The two brake circuits 4 and 5 are of identical construction, and therefore the construction of both brake circuits 4, 5 will be explained in greater detail below on the basis of brake circuit 4.

Brake circuit 4 is initially connected to a master brake cylinder 6 of brake pedal unit 3, master brake cylinder 6 being configured in the present case as a double-piston cylinder or tandem cylinder, and brake pedal unit 3 additionally including a brake pedal 7 that is actuatable by the driver. Brake circuit 4 includes a switching valve 8, downstream from master brake cylinder 6. Switching valve 8 is configured to be normally open and enables a flow of the hydraulic medium of the brake circuit, i.e., the brake fluid, in both directions. Switching valve 8 is additionally connected to the two wheel brakes 2, in each case with the interposition of an inlet valve 10 which is configured to be normally open in both directions. Also assigned to each of wheel brakes 2 of brake circuit 4 is an outlet valve 11, which is configured to be normally closed. Outlet valves 11 are connected on the outlet side to a hydraulic tank 9, which supplies master brake cylinder 6 with hydraulic medium. Outlet valves 11 are additionally connected on the outlet side to a suction side of a pump 13, which on the pressure side is connected to brake circuit 4 between switching valve 8 and inlet valves 10. In the present case, pump 13 is configured as a piston pump and is mechanically coupled to an electric motor 14, the pump 13 and the electric motor 14 together forming a pressure generator 15 of braking system 1. It is provided that electric motor 14 is assigned to pumps 13 of both brake circuits 4 and 5. Alternatively, it may also be provided that each brake circuit 4, 5 includes its own electric motor 14. A hydraulic pedal feel simulator 12 is also assigned to master brake cylinder 6.

If the two switching valves 8 of brake circuits 4, 5 are closed, the hydraulic pressure remains trapped or maintained in the downstream section of brake circuits 4, 5, i.e., between the switching valves and wheel brakes 2, even when brake pedal 7 is released by the driver. To boost the braking force, pressure generator 15 is actuated so that, in addition to the actuation of brake pedal 7, the hydraulic pressure is automatically increased by pressure generator 15 in braking system 1, so that the driver may generate a high braking torque with little effort.

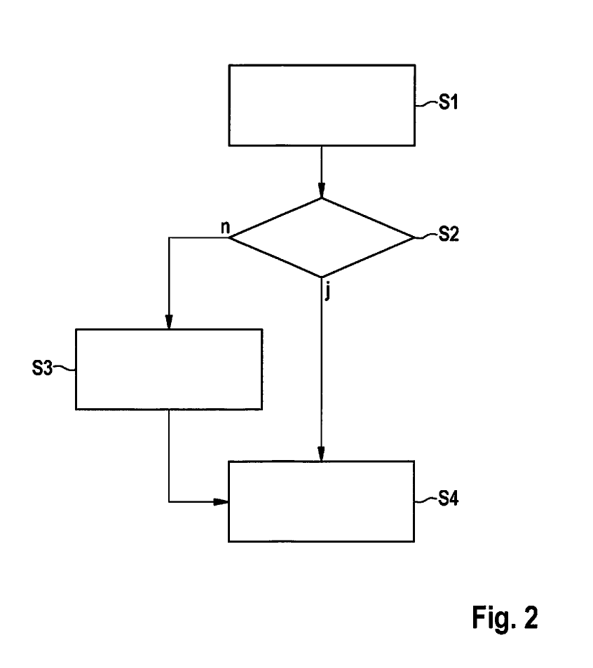

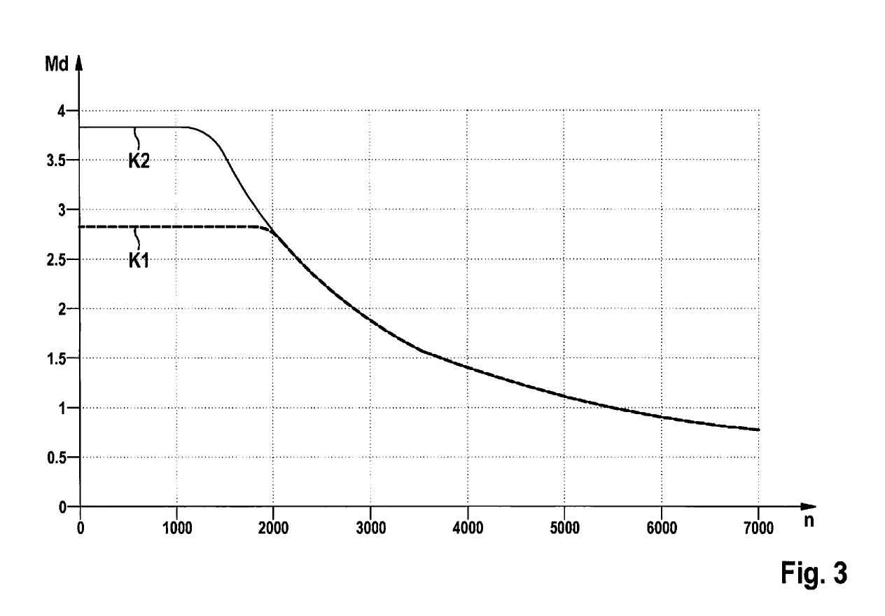

FIG. 2 shows a simplified flow chart to explain one advantageous method for operating the braking system. The method is started in first step S1 by actuating brake pedal 7 of brake pedal unit 3. In a subsequent query S2, it is checked whether the brake pedal actuation is a highly dynamic brake pedal actuation. For this purpose, the actuation speed and the actuation travel of brake pedal 7 are detected and are each compared with a limiting value. If the detected brake pedal travel exceeds the associated limiting value and if the actuation speed is higher than the corresponding limiting value, it is recognized that a highly dynamic brake actuation is taking place (j). However, if the actuation speed is lower than the limiting value and/or if the brake pedal is not moved beyond the pedal travel permitted by the associated limiting value, it is recognized that no highly dynamic brake pedal actuation is taking place (n) and the method advances to a step S3. In this step, the operating current for pressure generator 15 is limited to the permissible first limiting value.

In order to prevent overheating of pressure generator 15 or of an electric motor of pressure generator 15, it is provided that the operating current of the pressure generator is limited by a first limiting value during normal operation. This will be explained in greater detail with reference to the method shown in FIG. 2.

With the operating current thus limited, pressure generator 15 is then actuated in step S4 to generate the hydraulic pressure. However, if it is recognized in step S2 that the brake pedal actuation is a highly dynamic brake pedal actuation (j), then the method advances from step S2 to step S4, so that the limitation of the operating current does not take place or is canceled. As a result, in the event of a highly dynamic braking operation, pressure generator 15 may be supplied with an increased operating current so that it provides a high torque even at low rotational speeds, so that the hydraulic pressure in braking system 1 is built up in a very short period of time. Because the limitation is canceled only for highly dynamic braking operations, it is ensured during normal operation that the operating temperature is not exceeded. In a highly dynamic braking operation, the thermal load depends on the magnitude and duration of the operating current. Because the operating current is high only for a short period of time in the event of a highly dynamic braking operation, in particular for as long as low rotational speeds prevail, the adverse effect of the operating temperature for this short period of time is insignificant. The increase in the operating current beyond the first limiting value is thus advantageously permitted by the described method. The torque of electric motor 14 in the event of a highly dynamic braking operation thus increases in the same way as for a normal braking operation, the exact magnitude or torque increase being dependent on the size of the electric motor and on the implemented current limits.

FIG. 3 shows, by way of example, a diagram of the torque characteristic curve of electric motor 14 of pressure generator 15, as the torque M_{d} over rotational speed n, during normal operation (K1) and in the event of a highly dynamic braking operation (K2). It is apparent that at low rotational speeds a higher torque is permitted for the highly dynamic braking operation, while at higher rotational speeds above 2000 rpm the characteristic curves K1 and K2 lie one on top of the other.

1-9. (canceled)

10. A method for operating a hydraulic braking system of a motor vehicle, the hydraulic braking system including at least one hydraulically actuatable wheel brake, a brake pedal unit including an actuatable brake pedal for predefining a setpoint braking torque, and a pressure generator, the method comprising:
electrically actuating the pressure generator to generate a hydraulic pressure as a function of the setpoint braking torque, wherein an electrical operating current of the pressure generator is limited to a first predefinable limiting value during normal operation;
monitoring the brake pedal unit for the nature of actuation of the brake pedal; and
canceling the limitation of the operating current if a highly dynamic actuation of the brake pedal is detected.

11. The method of claim 10, wherein a highly dynamic actuation is recognized if a detected brake pedal actuation speed exceeds a predefinable second limiting value.

12. The method of claim 10, wherein a highly dynamic actuation is recognized if a detected brake pedal travel exceeds a predefinable third limiting value.

13. The method of claim 10, wherein the first limiting value is predefined as a function of an operating temperature of the pressure generator.

14. The method of claim 10, wherein the limitation by the first limiting value takes place only at rotational speeds below a fourth limiting value.

15. The method of claim 10, wherein the first limiting value is predefined as a function of a permissible operating temperature of the pressure generator during a long-term brake application.

16. The method of claim 10, wherein the brake pedal unit generates a status report as a function of the detected nature of the brake pedal actuation and sends it to a control unit which actuates the pressure generator.

17. A device for operating a braking system of a motor vehicle, the braking system including at least one wheel brake, a brake pedal unit including an actuatable brake pedal for predefining a setpoint braking torque, and at least one pressure generator for hydraulically actuating the wheel brake, the pressure generator being actuated as a function of an actuation of the brake pedal, comprising:
a control unit for operating the hydraulic braking system by performing the following:
electrically actuating the pressure generator to generate a hydraulic pressure as a function of the setpoint braking torque, wherein an electrical operating current of the pressure generator is limited to a first predefinable limiting value during normal operation;
monitoring the brake pedal unit for the nature of actuation of the brake pedal; and
canceling the limitation of the operating current if a highly dynamic actuation of the brake pedal is detected.

18. A braking system for a motor vehicle, comprising:
at least one wheel brake;
a brake pedal unit; and
at least one pressure generator for hydraulically actuating the wheel brake, wherein the pressure generator is actuated as a function of an actuation of the brake pedal; and
a device for operating the braking system, the braking system including the at least one wheel brake, the brake pedal unit including an actuatable brake pedal for predefining a setpoint braking torque, and the at least one pressure generator for hydraulically actuating the wheel brake, the pressure generator being actuated as a function of an actuation of the brake pedal, including a control unit for operating the hydraulic braking system by performing the following:
electrically actuating the pressure generator to generate a hydraulic pressure as a function of the setpoint braking torque, wherein an electrical operating current of the pressure generator is limited to a first predefinable limiting value during normal operation;
monitoring the brake pedal unit for the nature of actuation of the brake pedal; and
canceling the limitation of the operating current if a highly dynamic actuation of the brake pedal is detected.
